(19) United States
(12) Patent Application Publication
(10) Pub. No.: US 2004/0062958 A1
(43) Pub. Date: Apr. 1, 2004

(54) Method of short-circuitting a malfunctioning elementary eletrochemical cell of a filter-press structure

(76) Inventors: Daniele Facchi, Rovato (IT); Antonio Toro, Milan (IT); Paolo Binelli, Milan (IT)

Correspondence Address: Bierman Muserlian & Lucas, 600 Third Avenue, New York, NY, 10016, US

(21) Appl. No.: 10/467,284

(22) PCT Filed: Mar. 6, 2002
(86) PCT No.: PCT/EP02/02468

(30) Foreign Application Priority Data
Mar. 6, 2001 (IT) MI2001A000458

(51) Int. Cl. H01M 8/00; H01M 8/10

(52) U.S. Cl. 429/13; 429/32; 429/35

(57) ABSTRACT

It is described a method of electrical by-passing of an elementary electrochemical cell, for instance a fuel cell, inserted in a filter-press structure delimited by electrically conducting bipolar sheets and provided with perimetral sealing gaskets, comprising short-circuiting the cell by insertion of a conductive material within recesses realised by perforation of materials interposed between the bipolar sheets. The gaskets and the bipolar sheets may be provided with sites predisposed to the perforation, for instance notches for a drilling tip, or gasket regions of decreased hardness.

The present invention concerns a method of short-circuiting a malfunctioning elementary electrochemical cell of a filter-press structure.

### DESCRIPTION OF THE INVENTION

Processes of electrolysis or electric energy generation based on filter-press type structures realising an electrochemical cell assembly are known in the art. The typical elementary electrochemical cell in which such processes are carried out normally has a limited thickness, to minimise the energetic consumption. The elementary cell is typically limited by two conductive sheets between which a couple of sealing gaskets directed to the sealing of the periphery, an ion-exchange membrane, a pair of electrodes and a pair of current collectors/distributors are comprised. Holes are made in the sheets and/or the gaskets, communicating with the anodic and cathodic chambers by means of distribution channels. A multiplicity of elementary cells is conventionally assembled in the filter-press mode to make up an electrolyser or electric energy generator. Thus the electrolyser or the generator are constituted by a sequence of bipolar sheets, gaskets, membranes, electrodes and collectors/distributors. In particular the coupling of the holes of the sheets and of the gaskets determines the formation of longitudinal ducts connected to appropriate nozzles placed at one or both ends of the electrolyser or generator. Reactants are fed and reaction products, eventually mixed with the residual reactants, are withdrawn through the nozzles and the ducts. The reactants are then distributed to each elementary cell through the distribution channels. The products and the eventual residual reactants are withdrawn in the same fashion. An assembly of elementary cells of the above cited type is described in the European Patent Application EP 629015. These assemblies, mostly being electrical systems with a typical connection in series, are put out of function even when a single constituting elementary cell is defective. As a defective cell it is intended a cell in which even a single electrode (for instance due to the scarce activity of the electrocatalytic material) or collector (for instance due to excessive electric resistance arising from incorrect composition or mechanical characteristics) is not working properly, or finally in which the membrane results punched. This last case is particularly serious as it leads to the mixing of mutually incompatible reactants and products, as is the case of electric energy generators wherein a hole in a membrane causes the mixing of hydrogen and oxygen with subsequent ignition of the mixture on the electrocatalytic s material of the electrodes. The method of externally short-circuiting the defective elementary cell disclosed in EP 629015 can thereby be advantageously coupled to a method for the hydraulic by-passing of the same, as described, for instance, in U.S. Pat. No. 5,876,583.

In many cases, however, the electric short-circuiting of single cells performed according to the teaching of EP 629015 presents remarkable drawbacks: the following description will make reference to the particular case of polymeric membrane fuel cells, as in this kind of application where such drawbacks are more serious and evident. It will result however totally clear to the experts in the art that the same arguments hold, in a more or less pronounced way, for all the solid electrolyte electrochemical cells disposed in electric series and arranged according to a filter-press configuration.

The short-circuiting method cited in EP 629015 foresees that the bipolar sheets be provided with external protrusions, whose alignment determines a series of slots, each of them being in correspondence with one elementary cell. If one of the elementary cells is defective, a suitably shaped electroconductive material is inserted in the corresponding slot, thereby effecting a short-circuiting with consequent electrical by-passing of the relevant elementary cell.

The first disadvantage of this method consists in the additional weights and volumes associated to the external protrusions of the bipolar sheets. In many fuel cell applications, and in particular in the mobile uses (such as the automotive applications), the maximisation of the specific power, both expressed as the power installed by unit weight, and as the power by unit volume, are one of the fundamental issues to be developed in order to achieve the commercial exploitation of the product. It is thereby desirable to realise fuel cell stacks as compact as possible, wherein the active portion which is the site of the electrochemical reactions coincides as far as possible with the effective bulk dimensions. This requirement is incompatible with having bipolar sheets provided with external protrusions not contributing to the generation of electric energy. Moreover, these protrusions must be dimensioned according to the electric current intensity traversing the stack, in order to avoid hazardous local overheating. In fact, by way of the peripheral short-circuiting according to the teaching of EP 629015, the whole of the electric current generated by the stack must flow across the surface of the electroconductive material interposed within the slot defined by the protrusions of said sheets, in order to pass from the first bipolar sheet subjected to the short-circuiting to the other; it is evident that, the lower such transfer surface is, the higher will be the relative electric resistance. To minimise the installation costs and increase the specific power of fuel cell stacks, there's always more a tendency to increase the operative current density of these units meanwhile increasing the total active surface of the elementary cells, thereby decreasing, for the same installed power, the number of elementary cells. This gives rise to the fact that the operative current density of these generators reaches in many cases the several hundreds of Amps, obliging to a really onerous dimensioning of the protrusions of the sheets, to avoid reaching temperatures dangerous to the integrity of materials.

In many cases, however, even an appropriate dimensioning of the protrusions of the sheets is not sufficient, as the electric current, besides having to overcome the electroconductive material-filled slot along the peripheral region of the two sheets delimiting the elementary cell to be by-passed, must also flow in the transversal direction along the surface of the two sheets in order to reach said peripheral region. Remarkable resistive penalties can be associated also to this path, especially when the active surface is, as previously mentioned, very large, so that the path of the current lines from the central zone to the periphery of the bipolar sheets has a conspicuous length. The phenomenon is even more emphasised by the use, nowadays quite common, of very thin bipolar sheets; the latter are again privileged with the purpose of minimising weights and volumes, however they provide a lower passage section to the current that must cross them transversally. Furthermore, among the materials most often used for the construction of the sheets there are a few, such as stainless steel, very good form the standpoint of corrosion resistance but less outstanding as far as electric characteristics are concerned, further enhancing the problem.

### OBJECTS OF THE INVENTION

It is an object of the present invention to provide a method for the short-circuiting of elements of solid electrolyte electrochemical cell stacks, connected in electric series and arranged according to a filter-press type configuration. Under a further aspect, it is a further object of the present invention to provide a solid electrolyte electrochemical cell stack comprising elements adapted for the insertion of a means for short-circuiting.

### BRIEF DESCRIPTION OF THE FIGURES

The invention will be described making reference to the figures, wherein:

FIG. 1 shows a stack of electrochemical cells according to the invention;

FIG. 2 shows a section of an electrochemical cell according to an embodiment of the invention and

FIG. 3 shows a section of an electrochemical cell according to an alternative embodiment of the invention.

### DETAILED DESCRIPTION OF THE INVENTION

The invention consists in the insertion of a conductive material, preferably of elongated shape, for instance in the form of thread, fibre, rod, tube or bar, within one or more recesses obtained by perforating the materials interposed between two bipolar sheets delimiting the cell element to be short-circuited.

According to a preferred embodiment, one or more recesses are obtained through a perforation effected within the cell element, with consequent destruction and/or displacement of the material non provided with electronic conductivity along the perforation path, and said insertion of material is effected into said recesses, so as to achieve the electric continuity.

According to a further preferred embodiment, said recesses are obtained by perforation with destruction and/or displacement of all the material, provided or non provided with electronic conductivity, interposed between said bipolar sheet along the path of the same perforation, and the conductive material subsequently inserted in said recesses directly contacts the internal walls of said bipolar sheets. According to a further preferred embodiment, at least one of said recesses is obtained by drilling, and the insertion of conductive material into said recesses is carried out subsequently.

According to an alternative embodiment, at least one of said recesses is obtained by drilling with a metallic tip, and said metallic tip is subsequently left inside said recess to achieve the electric continuity.

According to another preferred embodiment, the short-circuiting operation, effected by means of one of the previously described embodiments, is preceded by the hydraulic by-passing of the cell to be short-circuited, for instance through injection of a suitable sealant in correspondence of the inlets, and optionally also of the outlets, of the circulating fluid circuits.

According to another preferred embodiment, the perforations to obtain the recesses wherein the conductive material is inserted are effected in predisposed locations, adapted to the scope.

According to a further preferred embodiment, such predisposed locations adapted to the scope are realised so as to present a lower thickness of material to be displaced, by means of suitable indentations, niches or other particular shaping.

The following examples will illustrate some possible embodiments of the short-circuiting method according to the invention, even though they shall not be intended by any means as a limitation of the same:

### EXAMPLE 1

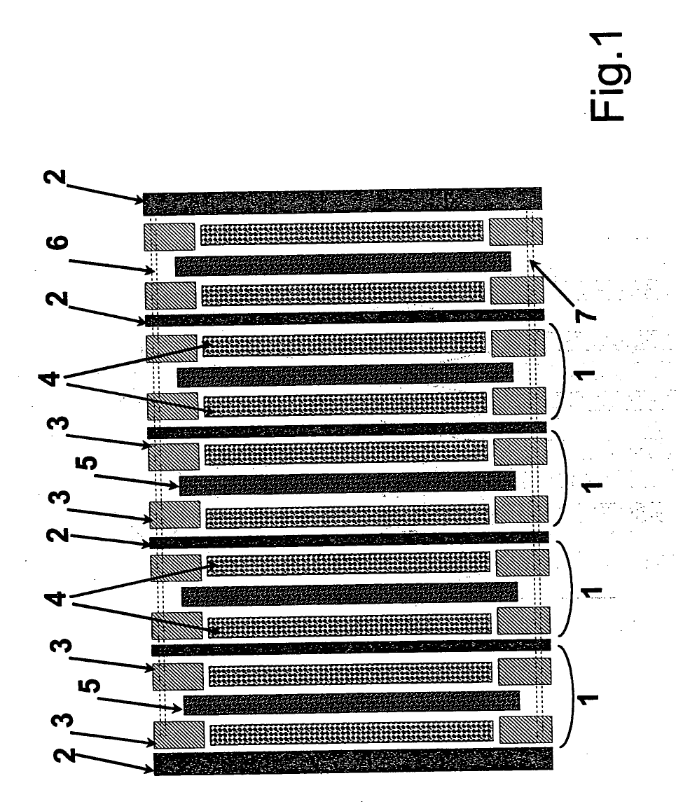

A typical embodiment of short-circuiting according to the invention is relative to the by-passing of an elementary cell belonging to a fuel cell stack, laminated according to the arrangement of the filter-press type displayed in FIG. 1. The stack comprises elementary cells (1), delimited by bipolar or terminal conductive sheets (2), for example of metallic material such as stainless steel, aluminium or alloys thereof, nickel or alloys thereof, titanium or alloys thereof, optionally coated with corrosion resistant conductive paints. The bipolar sheets may however also be made of non-metallic materials, for instance of graphite or conductive plastic materials. The fluid sealing between one cell and the next and towards the exterior are ensured by suitable gaskets (3), for instance plastic or metallic gaskets. The figures show frame-shaped planar gaskets, but it is apparent that the invention may be practised also with O-ring type sealing systems, or with differently shaped gaskets. FIG. 1 also shows a current collector (4) physically distinct from the adjacent bipolar sheet; as the current collector it is possible to employ a metallic material or an arrangement of metallic materials selected from the group of meshes, sponges, foams, mattresses, shaped or ribbed sheets, expanded sheets optionally flattened, sintered materials.

The collector may be also non-metallic, for example it may be constituted by a graphitic material, or by graphitised carbon, or by an arrangement of such materials with different geometry. It is however evident that the invention may be practised also when the bipolar sheet and the current collector are made by a single integrated element, for instance by a suitably ribbed plate, or by a plate having a fluid impermeable region, having the function of separator, and a porous region, having the function of reactant distributor. Each cell is divided in two compartments, anodic and cathodic, by a solid electrolyte, typically by an ion-exchange membrane(5), usually provided with a catalytic coating on one or both surfaces thereof, to favour the electrochemical reactions at the two compartments; the electrocatalytic coating acts thereby as the electrode. The solid electrolyte is typically an ionic conductor, which conversely does not own a significant electronic conductivity, so as to maximise the voltage between the compartments of the cell given a fixed generated electric current, thereby increasing the electric efficiency of the system. Although the figure shows a membrane optionally provided with a catalytic coating having electrodic function, it is apparent how the invention may be practised also with electrodes, catalysed or non-catalysed, physically distinct from the membrane and interposed between the membrane itself and the relative current collector. As it is implicit in the concept of filter-press type arrangement, suitable openings provided on the laminated elements create ducts that are employed for other purposes, by means of design techniques known to the experts of the field. For instance, FIG. 1 shows a collector for feeding the reactants (6) and one for draining the exhausts and the reaction products (7), obtained by juxtaposition of suitable holes provided on the plane of the bipolar sheets and of the gaskets; it is evident that the one shown is just one possible embodiment, but that other embodiments may be easily identified to achieve the aim of the invention; for instance, also the membrane (5) may have dimensions equivalent to those of the bipolar sheets, and be provided with suitable holes, concurring to the delimitation of the feeding and draining collectors displayed; also the relative position of the fluid collectors could be inverted or varied in any manner, without departing from the scope of the invention. Other ducts that may be present, not shown, obtained by the filter-press type lamination, are for example those for the passage of thermal regulating fluids or of water for humidification, or the housing of the tie-rods for clamping the assembly.

Preferably, prior to practising the method of the invention for the short-circuiting of a cell, the hydraulic by-passing of the same is carried out by means of the method disclosed in U.S. Pat. No. 5,876,583.

The invention foresees that the short-circuiting be effected creating one or more recesses parallel to the plane of the bipolar sheet to be put in electric communication, locally displacing at least the materials lacking electronic conductivity; in the case shown in FIG. 1, for instance, it is necessary that such recesses be pierced displacing the membrane (5) along the path. Preferably, the displacement of all the materials comprised between the two adjacent bipolar sheets to be short-circuited will be carried out; in the case of the stack shown in FIG. 1, it will thereby be preferable to pierce such recesses displacing along the path, besides the membrane (5), also the current collectors (4), perforating the portion of gasket (3) insulating the latter from the outside. The perforation will be preferably carried out by means of a drill, provided with a tip of diameter generally corresponding to the distance between the two sheets to be short-circuited, extracting the biggest possible part of the debris and pushing the rest to the extremity of-the recess so obtained. In most of the cases it is preferable to pierce a multiplicity of generally parallel recesses, mutually spaced so as to distribute the contact appropriately. The bigger is the cell height and the lower is the surface conductivity of the sheets, the greater number of recesses will be needed.

After obtaining the recesses as described, the insertion of conductive material must be carried out to achieve the electric continuity between the adjacent bipolar sheets to be short-circuited. In a preferred embodiment, according to which the recesses are pierced by drilling, said recesses have a cylindrical shape and the conductor will preferably be in the form of a cable or metallic rod; in another more preferred embodiment, the conductive material that is inserted has a shape suitable to provide an adequate elasticity under compression, so as to retain an optimal electric contact with the walls of the short-circuited bipolar plates with time. Suitable shapes are thin tubes, spiralled rods, rods with V-shaped, omega (Ω)-shaped or elliptic sector-shaped section. The conductor is preferably made of a metal with high electric conductivity, such as aluminium, copper, nickel, silver, or alloys thereof. In the case of metals that passivate giving rise to scarcely conductive oxides, the conductive material may be coated with a non-passivatable conductive layer, for example gold, silver or other noble metals. In other embodiments, the conductive material may be made of bundles of fibres, wires, bars of different sections; it is also possible to inject a metallic or carbon-based conductive paste into the recess, so as to achieve the electric continuity. In an alternative embodiment, it is possible to create the recess by means of a drill provided with a metallic tip with sufficient conductivity, releasing thereafter said tip from the drill and leaving it in place, achieving thereby the short-circuiting in a single step.

In another preferred embodiment of single step short-circuiting, it is possible to create the recess simultaneously short-circuiting the cell by inserting one or more conic-tipped or wedge-tipped conductors, for instance a series of metallic awls, by pounding or other equivalent mechanical action, for instance with a mallet or hammer.

### EXAMPLE 2

Another aspect of the present invention consists in adapting the design of some components of the electrochemical cell arrangement, for instance of a fuel cell stack as the one shown in FIG. 1, so as to facilitate the above disclosed short-circuiting procedure.

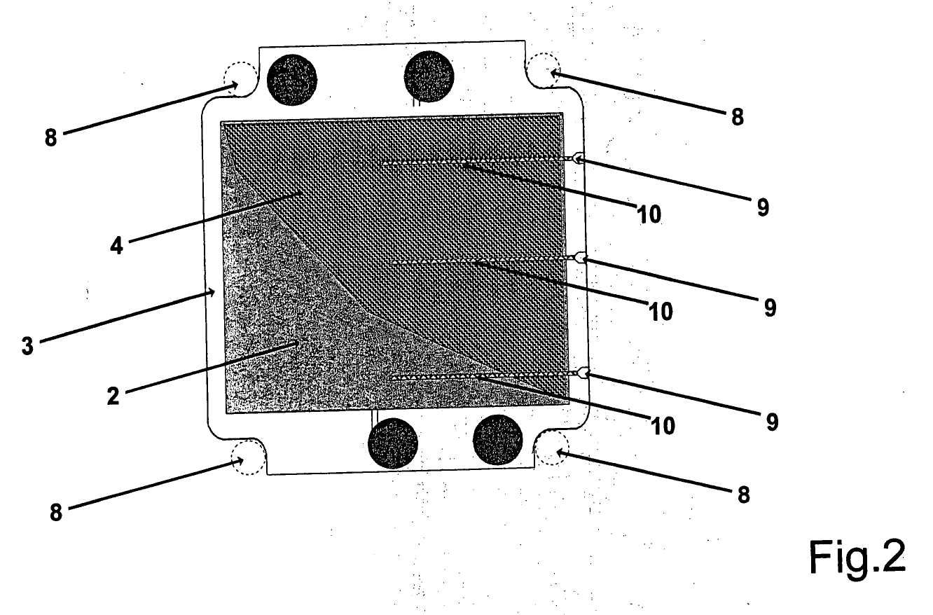

FIG. 2 shows a section of a fuel cell constituting one of the elements of the stack in FIG. 1, according to a particular embodiment of the invention; it is understood that the constructive concepts exposed hereafter may be equally applied to the case of electrolysers or other electrochemical cells.

In particular, the cell of FIG. 2, of which is shown the frame-shaped gasket (3), whose central window constitutes the housing for the current collector (4), only partially shown, overlapped to the bipolar sheet (2), foresees the passage of the clamping tie-rods (8) externally with respect to the main surface. In this case, the short-circuiting may be effected by piercing the recess (10) in any point of the cell side-walls, in correspondence of the housing for the current collector. To help the formation of the short-circuiting recesses (10), by means of any method of the example 1, it is possible to predispose one or more perforation zones (9) suited to the scope along the sides of the gaskets. The perforation zones (9) may consist in notches, indentations or recesses of various geometries characterised by a locally reduced thickness, so as to favour the local displacement of the gasketing material, which in many cases may have a considerable hardness, as is the case of certain types of gaskets of thermoplastic material. The perforation zones may also be characterised by a different material, preferably softer, with respect to the bulk of the gasket; for example, in the perforation zones, the gasket may be made of an elastomeric material such as silicon rubber, polytetrafluoroethylene, EPDM or others, eventually less preferred for reasons of cost or mechanical characteristics with respect to the materials employed for the bulk of the gasket, yet of great utility in regions of limited extension such as the perforation zones. Also the profile of the bipolar sheet, in the perimetral region in correspondence with the perforation zones, may be provided with suitable sites which help the placement of the equipment employed for the creation of the short-circuiting recesses, for instance notches for the optimal placement of an awl or of a drilling tip.

### EXAMPLE 3

Another aspect of the present invention consists in a method that facilitates the short-circuiting of cells in which the presence of tie-rods inside the active area of the cell, or in any case of the main surface of the same, is foreseen.

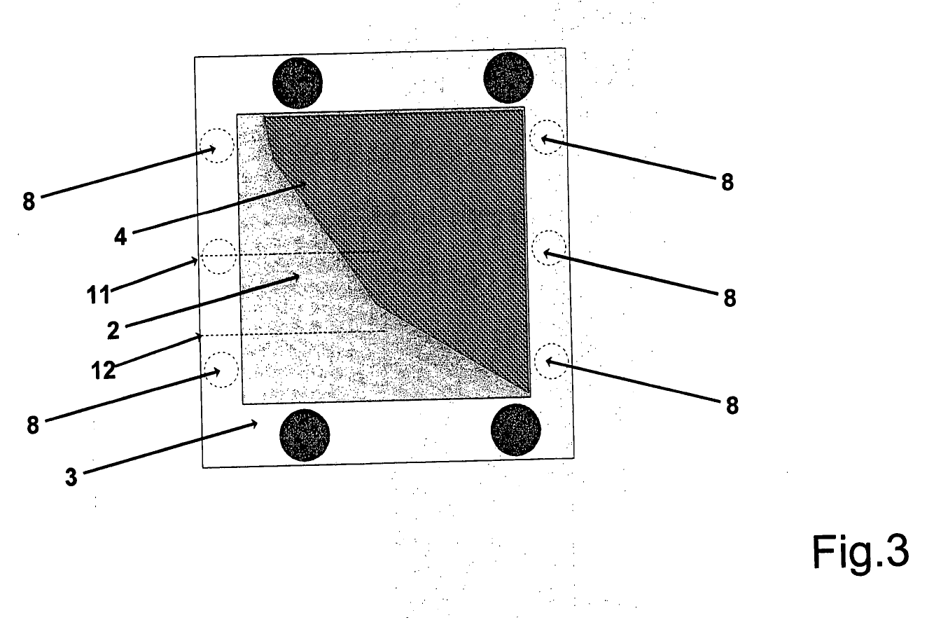

FIG. 3 shows a section of a fuel cell constituting one of the elements of the stack of FIG. 1, according to a particular embodiment of the invention; it is understood that the constructive concepts exposed hereafter can be equally applied to the case of electrolysers or of other electrochemical cells. In particular, the cell of FIG. 3, of which it is displayed the frame-shaped gasket (3), whose central window constitutes the housing for the current collector (4), only partially shown, said gasket and said collector overlapped to the bipolar sheet (2), foresees the passage of the tie-rods (8) within the main surface of the cell. In this case, to form more easily the short-circuiting recesses, minimising the amount of material to displace and the extension of said recesses, it is convenient to locate said recesses exactly in correspondence of one of said tie-rods, after removing the latter. It is in fact evident from FIG. 3 how the realisation of the piercing in correspondence of the line (11), that crosses the passage of a tie-rod, instead of the generic line (12), involves a perforation path reduced of about one tie-rod's diameter; moreover, the saved perforation path corresponds, in the drawing of FIG. 3, to a segment of gasket, which in most of the cases is the material constituting the hardest obstacle to overcome, as it tends to elastically absorb part of the mechanical energy, especially when an awl is used, or to adhere to the drilling tip softening its profile, when drills are selected to carry out the job. The realisation of the piercing in correspondence of a tie-rod in this case not only shortens the working time, but also determines a lower encumbrance by the debris of displaced material, which might sensibly hinder the operation, especially in the case of plastic material.

A preferred short-circuiting method for an electrochemical cell part of a filter-press arrangement, delimited by electrically conductive bipolar sheets and provided with passages for the clamping tie-rods within the main surface of the cell, foresees that the load on at least one of the tie-rods, and preferably on a single one, be loosened, and said tie-rod be extracted from its site while the remaining tie-rods maintain the clamping of the filter-press arrangement; that a piercing be effected in correspondence of the passage zone of said extracted tie-rod between the two bipolar sheets to be short-circuited, so as to displace the material lacking electronic conductivity from the perforation path; that subsequently or simultaneously a conductive material be inserted to put the bipolar sheets delimiting the cell to be short-circuited in electric communication. The procedure may be repeated by extracting more tie-rods in sequence, preferably after inserting back the tie-rod that was extracted to accomplish the previous operation, restoring then the clamping load. Preferably, the frame-shaped peripheral sealing gasket (3) of each cell is provided with perforation zones predisposed accordingly as disclosed in the previous example, in correspondence of the zones of passage of the tie-rods (8). Also the bipolar sheets (2) may be appropriately predisposed, as disclosed in the previous example. Preferably, the cell short-circuiting operation is preceded by the hydraulic by-passing of the same, by means of the injection of sealants or other equivalent method.

The illustrated examples shall not be understood as limiting the invention, which may be practised according to different embodiments without departing from the scopes thereof, and whose extent is solely defined by the following claims.

1. A method for electrically by-passing an elementary electrochemical cell of a filter-press structure, said elementary electrochemical cell being delimited by electrically conductive bipolar sheets and provided with perimetral sealing gaskets, said method comprising the short-circuiting of said elementary electrochemical cell by insertion of a conductive material within at least one recess obtained through the perforation of materials interposed between said electrically conductive bipolar sheets.

2. The method of claim 1 wherein all of said materials interposed between said electrically conductive bipolar sheets along the path of said perforation are displaced and a direct contact between said electrically conductive bipolar sheets and said conductive material is effected.

3. The method of the previous claims wherein said interposed materials comprise materials lacking electronic conductivity.

4. The method of claim 3 wherein said materials lacking electronic conductivity comprise a polymeric membrane.

5. The method of claims 1 or 2 wherein said interposed materials comprise materials lacking electronic conductivity and materials having electronic conductivity.

6. The method of claim 5 wherein said materials lacking electronic conductivity comprise a polymeric membrane and said materials having electronic conductivity comprise current collectors and said perimetral sealing gaskets.

7. The method of the previous claims, wherein said perforation is accomplished with a drill.

8. The method of claim 7, wherein said drill is provided with a metallic tip and that, after accomplishing said perforation, said metallic tip is left inside said at least one recess.

9. The method of claims 1 to 7 wherein said conductive material is a material with elongated shape selected from the group consisting of the rods, the bars, the cables, the bundles of fibres, the wires.

10. The method of claims 1 to 7 wherein said conductive material is a material retaining a residual elasticity under compression.

11. The method of claim 10 wherein said conductive material is selected form the group consisting of the tubes, the spiralled rods, the rods with V-shaped section, the rods with “omega”-shaped section, the rods with elliptic sector-shaped section.

12. The method of the previous claims wherein said conductive material is a metallic material with high electric conductivity optionally coated with a layer of noble metal.

13. The method of claims 1 to 7 wherein said conductive material is a conductive paste.

14. The method of claim 13 wherein said conductive paste is selected from the group consisting of metallic pastes and carbon-based pastes.

15. The method of claims 1 to 6 wherein said at least one recess is obtained through the insertion by pounding of a conductor provided with a conic-shaped-or wedge-shaped tip.

16. The method of claim 15 wherein said conductor provided with a conic-shaped or wedge-shaped tip is a metallic awl.

17. The method of the previous claims wherein said elementary electrochemical cell is a fuel cell.

18. The method of the previous claims wherein said filter-press structure comprises clamping tie-rods traversing the main surface of the elementary electrochemical cells, and that said at least one recess is obtained in correspondence of the passage zone of a tie-rod, after removal of said tie-rod.

19. The method of the previous claims wherein the perimetral sealing gaskets comprise predisposed perforation zones.

20. The method of claim 19 wherein in correspondence of said predisposed perforation zones the thickness of said perimetral gasket is reduced.

21. The method of claim 20 wherein said perforation zones are notches or indentations.

22. The method of claim 20 wherein in correspondence of said perforation zones the hardness of said gasket is reduced.

23. The method of claim 22 wherein said gasket is of thermoplastic material and that said perforation zones are of elastomeric material

24. The method of claims 19 to 23 wherein in correspondence of said perforation zones, said electrically conductive bipolar sheets comprise notches or drafts for positioning the equipment employed for said perforation.

25. The method of the previous claims further comprising the hydraulic by-passing of said elementary electrochemical cell.

26. The method of claim 25 wherein said hydraulic by-passing is effected prior to said short-circuiting.

27. An elementary electrochemical cell of a filter-press structure, said elementary electrochemical cell being delimited by electrically conductive bipolar sheets and provided with perimetral sealing gaskets, said elementary electrochemical cell comprising at least one recess obtained through the perforation of materials interposed between said electrically conductive bipolar sheets, in said at least one recess being inserted a conductive material for short-circuiting said elementary electrochemical cell.

28. The cell of claim 27 comprising further recesses, said recesses being parallel and mutually spaced.
